(19) United States
(12) Patent Application Publication
(10) Pub. No.: US 2024/0178430 A1
(43) Pub. Date: May 30, 2024

(54) TANK ENCLOSED INJECTION SYSTEM

(71) Applicant: ESS TECH, INC., Wilsonville, OR (US)

(72) Inventor: Joseph M. Cooley, Beaverton, OR (US)

(21) Appl. No.: 18/522,106

(22) Filed: Nov. 28, 2023

Related U.S. Application Data
(60) Provisional application No. 63/385,299, filed on Nov. 29, 2022.

(51) Int. Cl. H01M 8/18; H01M 8/22; H01M 50/35; H01M 50/627

(52) U.S. Cl. CPC H01M 8/188; H01M 8/22; H01M 50/35; H01M 50/627

(57) ABSTRACT

Systems and methods are provided for electrolyte health management in a redox flow battery system. In one example, the redox flow battery system includes an injector arranged inside of an electrolyte tank. The injector may be configured to entrain a gas into electrolyte flowing from an inlet of the injector to an outlet of the injector.

### CROSS REFERENCE TO RELATED APPLICATION

The present application claims priority to U.S. Provisional Application No. 63/385,299 entitled “TANK ENCLOSED INJECTION SYSTEM”, filed Nov. 29, 2022. The entire contents of the above identified application is hereby incorporated by reference for all purposes.

### FIELD

The present description relates generally to gas management in an electrochemical cell such as redox flow battery.

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. An all-iron hybrid redox flow battery is particularly attractive due to incorporation of low-cost, earth-abundant materials. In general, iron redox flow batteries (IFBs) rely on iron, salt, and water for electrolyte, thus including simple, earth-abundant, and inexpensive materials, and eliminating incorporation of harsh chemicals and reducing an environmental footprint thereof.

The IFB may include a positive (redox) electrode where a redox reaction occurs and a negative (plating) electrode where ferrous iron (Fe²⁺) in the electrolyte may be reduced and plated. Various side reactions may compete with the Fe²⁺ reduction, including proton reduction, iron corrosion, and iron plating oxidation:

H⁺+e⁻+½H₂ (proton reduction) (1)

Fe⁰+2H⁺↔Fe²⁺+H₂ (iron corrosion) (2)

2Fe³⁺+Fe⁰↔3Fe²⁺ (iron plating oxidation) (3)

As most side reactions occur at the plating electrode, IFB cycling capabilities may be limited by available iron plating on the plating electrode. Exemplary attempts to ameliorate iron plating loss have focused on catalytic electrolyte rebalancing to address hydrogen (H₂) gas generation from equations (1) and (2) and electrolyte charge imbalances (e.g., excess Fe³⁺) from equation (3) and ion crossover via equation (4):

Fe³⁺+½H₂→Fe²⁺+H⁺ (electrolyte rebalancing) (4)

To rebalance electrolyte via the electrolyte rebalancing reaction (equation 4), the redox flow battery system may have an electrolyte health system (EHS) that includes a rebalancing system wherein hydrogen gas is reacted with electrolyte in the presence of a catalyst. The source of hydrogen gas for the electrolyte rebalancing reaction may be hydrogen evolved from side reactions and/or hydrogen supplied from a separate hydrogen tank. For this reason, the redox flow battery system may demand transfer of hydrogen from storage areas (either from a head space of an electrolyte tank or a supplementary tank) to the rebalancing system and any unreacted hydrogen from the rebalancing reactor back to the storage areas.

In some examples, the rebalancing system may be a rebalancing reactor configured as trickle bed or jelly roll reactor set up, or the like. Electrolyte including hydrogen gas may contact catalyst within the rebalancing reactor. Additionally, the EHS may include a rebalancing cell for addressing rebalancing of iron species in the electrolyte. As an example, the rebalancing cell may be configured similar to a fuel cell, having a stack of electrode assemblies. Hydrogen gas generated as a byproduct may be drawn from various regions of the redox flow battery system to be reacted with ferric iron (Fe³⁺) at a catalyst. Reduction of ferrous iron to ferric iron (Fe²⁺) may therefore be similarly achieved via the rebalancing cell.

In some examples, flow of hydrogen through the EHS may be facilitated by injectors, such as venturi injectors, arranged along a gas path of the EHS. Discharge of hydrogen into pipes or passages coupled to an outlet of the injectors may be prone to backpressure, however, which may cause leakage of hydrogen to the surroundings, e.g., to the atmosphere. Such leaks may be difficult to detect and may incur frequent and costly repairs and maintenance. Furthermore, to offset loss of hydrogen due to leakage, larger pumps for driving gas flow to the injectors may be demanded which may add to a parasitic power burden on the redox flow battery system. The larger pumps may also increase a footprint and heat load of the redox flow battery system.

In one example, the issues described above may be at least partially addressed by a redox flow battery system having an injector arranged inside of an electrolyte tank. The injector may be configured to entrain a gas, e.g., hydrogen, into electrolyte flowing from an inlet of the injector to an outlet of the injector. In this way, loss of leaked hydrogen to the atmosphere may be mitigated while maintaining hydrogen flow in a low cost, efficient manner.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including an electrolyte tank having at least one injector positioned therein.

FIG. 2 shows a first example of an injector positioned within an electrolyte tank for drawing gas into the electrolyte tank.

FIG. 3 shows a second example of an injector positioned within an electrolyte tank for drawing gas into the electrolyte tank.

FIG. 4 shows a third example of an injector positioned within an electrolyte tank for drawing gas out of the electrolyte tank.

FIG. 5 shows an example of a method for delivering electrolyte to an electrolyte tank from a rebalancing cell to draw gas into an injector positioned inside the electrolyte tank.

FIG. 6 shows an example of a method for drawing gas from an electrolyte tank to a rebalancing reactor via an injector positioned inside the electrolyte tank.

FIG. 7A shows a first perspective view of a first example of a rebalancing cell including a stack of internally shorted electrode assemblies.

FIG. 7B shows a second perspective view of the rebalancing cell of FIG. 7A.

FIG. 8 shows a perspective side view of a catalyst bed which may be used in a rebalancing reactor, including sandwiched layers of a substrate, a catalyst, and a spacer, rolled up into a jelly roll structure.

### DETAILED DESCRIPTION

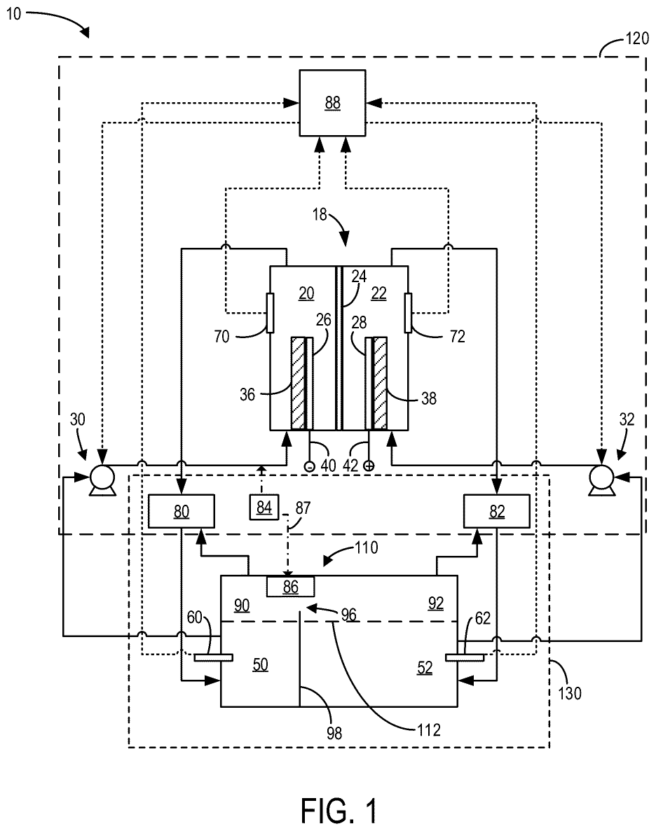

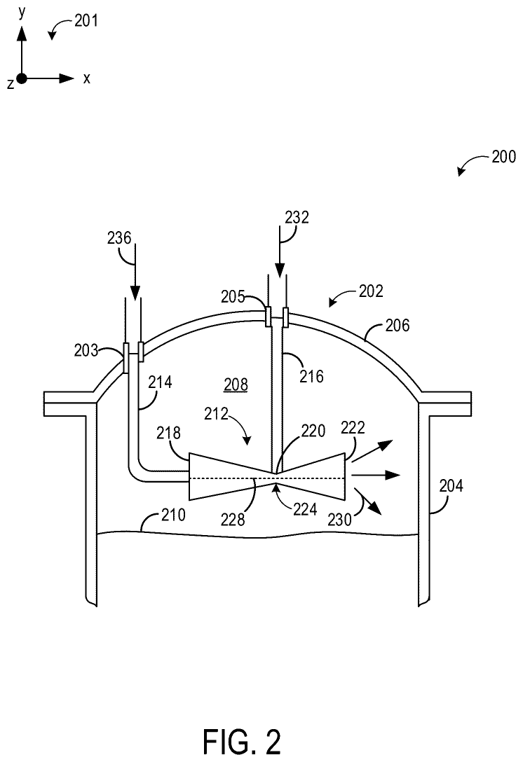

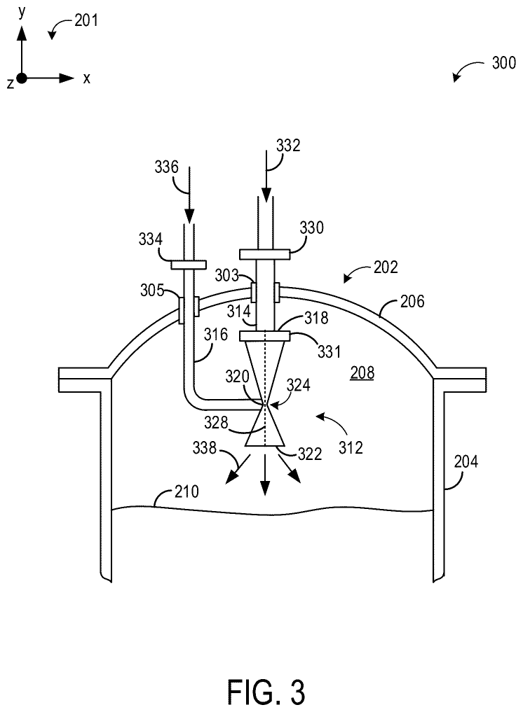

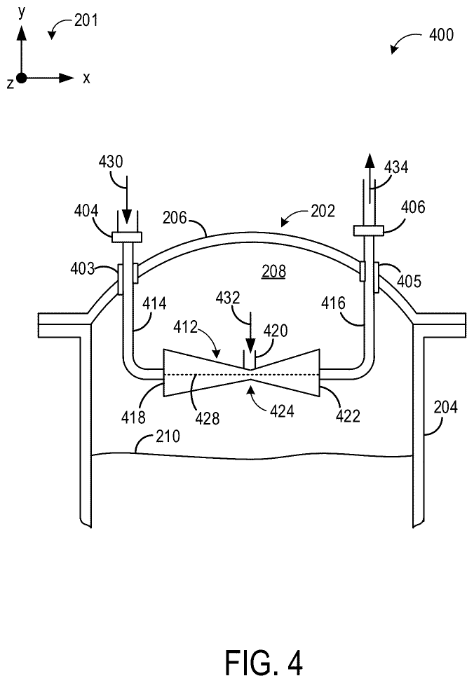

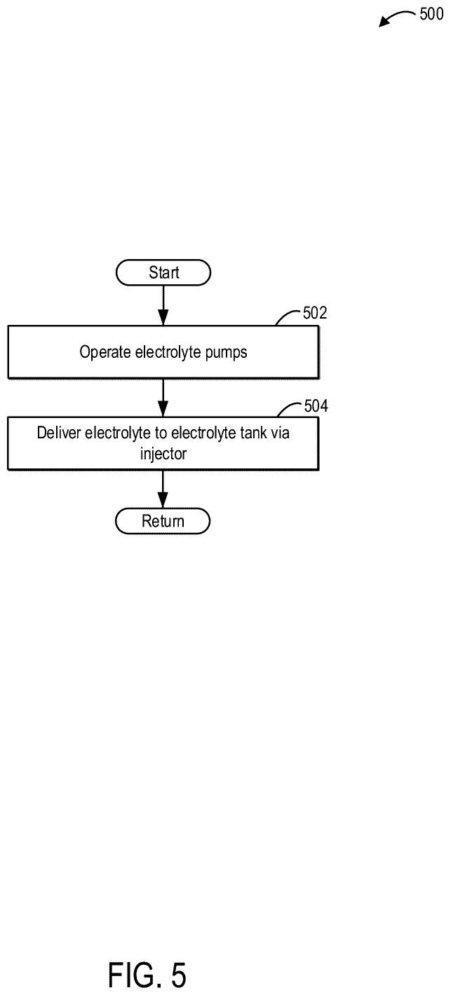

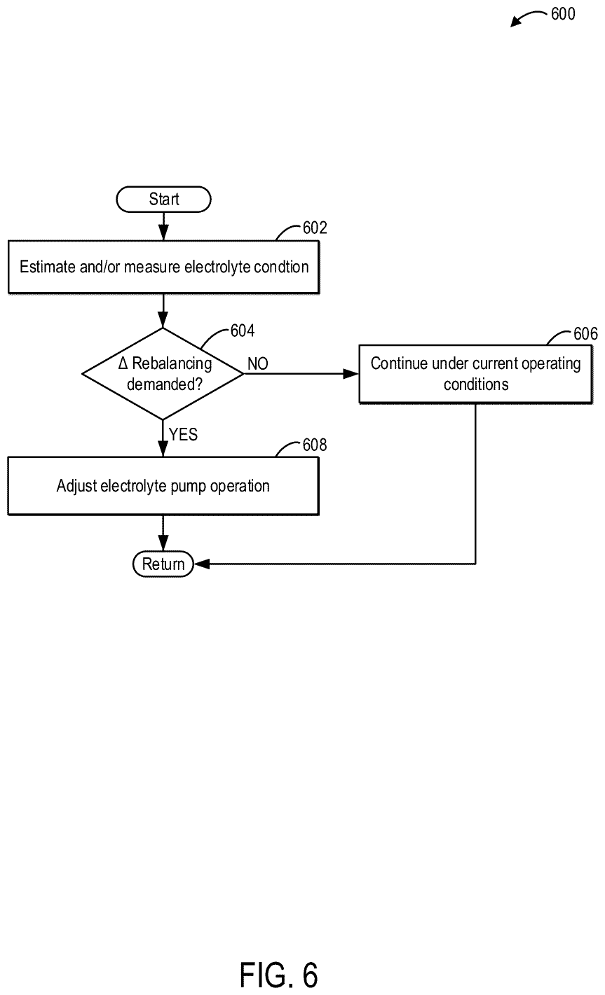

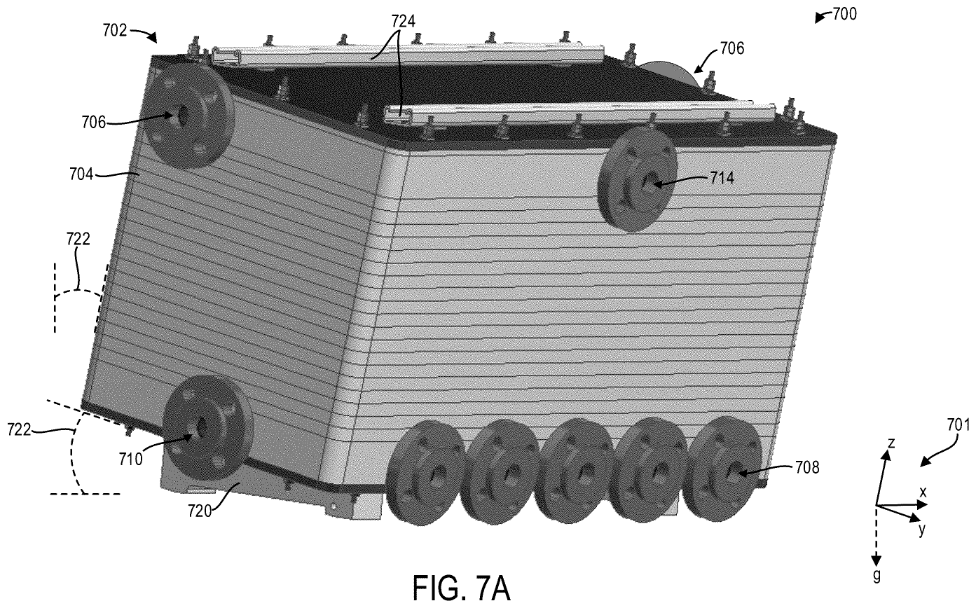

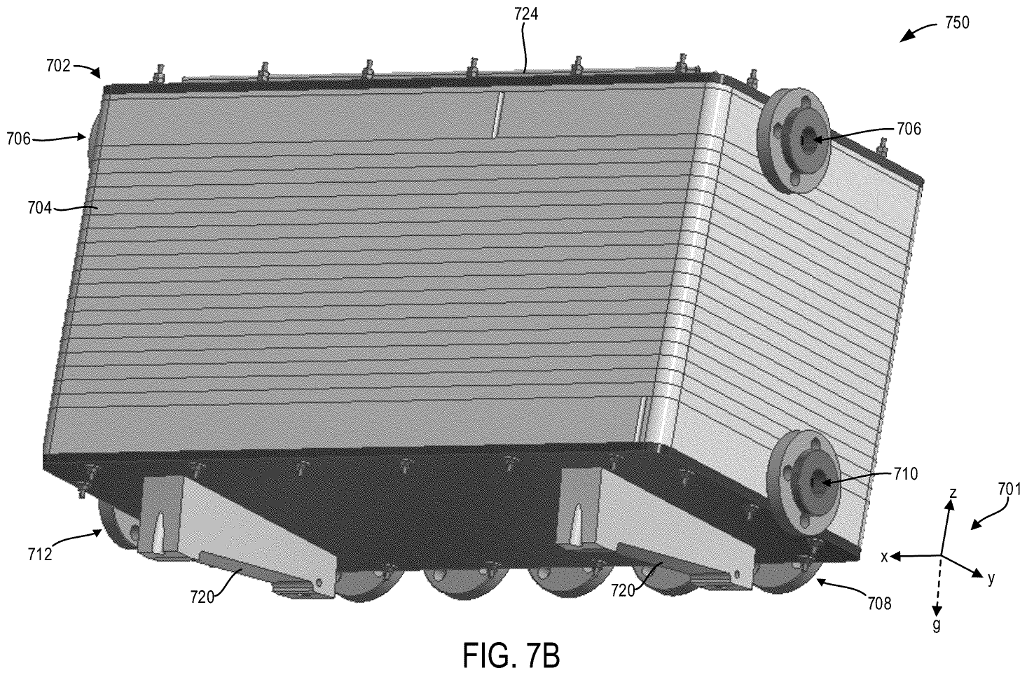

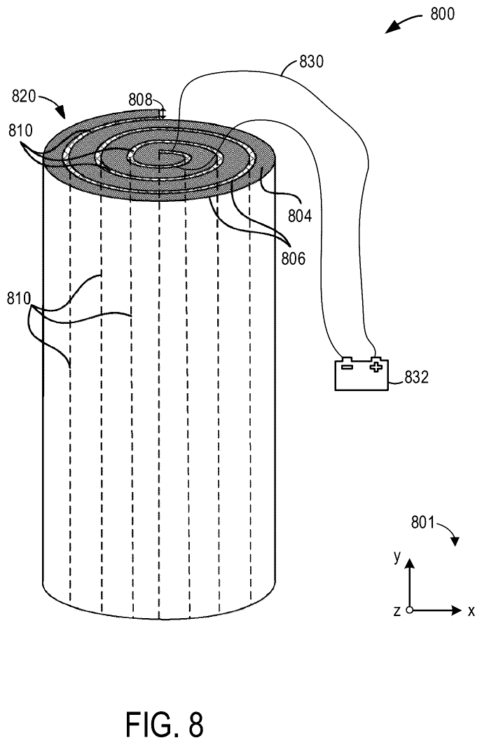

The following description relates to systems and methods for managing hydrogen gas in an electrochemical cell system. As one example, the electrochemical cell system may be a redox flow battery system. An example of a redox flow battery system including an electrolyte health system (EHS) is shown schematically in FIG. 1, where the EHS may demand management of gas flow therethrough. As described with respect to FIG. 1, the redox flow battery system may include at least one injector, such as a venturi injector, for circulating electrolyte and hydrogen gas between components of the EHS. The venturi injector, in one example, may be arranged within an electrolyte storage tank of the redox flow battery system, e.g., a tank-enclosed venturi injector. Electrolyte flow through the tank-enclosed venturi injector may drive discharge of hydrogen gas into the electrolyte storage tank, as illustrated with respect to FIGS. 2-3, thereby extracting hydrogen gas generated as a byproduct of redox reactions from regions of gas accumulation in the redox flow battery system. Electrolyte may be delivered to the tank-enclosed venturi injector of FIGS. 2-3 from a rebalancing cell, an example of which is shown in FIGS. 7A and 7B. In another example, as shown in FIG. 4, electrolyte flow through the venturi injector may discharge a two-phase flow comprising electrolyte and hydrogen gas, which may be directed to a rebalancing reactor. An example of a rebalancing reactor is shown in FIG. 8. Examples of methods for utilizing the tank-enclosed venturi injector in conjunction with a rebalancing cell and a rebalancing reactor are depicted, respectively, in FIGS. 5 and 6.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

Fe²⁺+2e⁻↔Fe⁰−0.44 V (negative electrode) (1)

Fe²⁺+>2Fe³⁺+2e⁻+0.77 V (positive electrode) (2)

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge, which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier that prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, via direct contact either therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment.

FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52 and at least one inlet to each of the negative and positive electrolyte chambers 50 and 52. Furthermore, one or more outlet connections may be provided from the gas head spaces 90 and 92 for directing H₂ gas to rebalancing systems 80 and 82.

The multi-chambered electrolyte storage tank 110 may be a component of an EHS of the redox flow battery system 10, the EHS further including rebalancing systems 80 and 82 for rebalancing electrolyte. The rebalancing systems 80, 82 may include one or more of rebalancing reactors and rebalancing cells for facilitating reduction of ferric iron to ferrous iron using hydrogen in the presence of a catalyst. When configured as the rebalancing reactors, the rebalancing systems 80, 82 may be arranged in a path of electrolyte flow between the redox flow battery cell 18 and the multi-chambered electrolyte storage tank 110, as described further below. When configured as the rebalancing cells, the rebalancing systems 80, 82 may be fluidically coupled to an electrolyte circuit of the redox flow battery system as an independent circuit that diverts at least a portion of the electrolyte flowing therethrough, as well as hydrogen gas generated within the redox flow battery system 10, to the rebalancing cells.

The electrolyte rebalancing systems 80 and 82 may be connected in line (e.g., as rebalancing reactors) or in parallel (e.g., as rebalancing cells) with the recirculating flow paths of the electrolyte at the negative and positive sides of the redox flow battery cell 18, respectively, in the redox flow battery system 10. Further, when configured as the rebalancing reactors, one or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the rebalancing reactors may be placed in a return flow path from the negative and positive electrode compartments 20 and 22 to the negative and positive electrolyte chambers 50 and 52, respectively.

The electrolyte rebalancing systems 80 and 82 may serve to rebalance electrolyte charge imbalances in the redox flow battery system 10 occurring due to side reactions, ion crossover, and the like, as described herein. In one example, the electrolyte rebalancing reactors may include trickle bed reactors, where the H₂ gas and electrolyte may be contacted at catalyst surfaces in a packed bed for carrying out the electrolyte rebalancing reaction. In other examples, the rebalancing reactors may include flow-through type reactors that are capable of contacting the H₂ gas and the electrolyte liquid and carrying out the electrolyte rebalancing reactions absent a packed catalyst bed. The rebalancing cells may be configured according to a fuel cell system, with stacks of electrode assemblies through which the electrolyte may be directed. A catalyst may also be included in the rebalancing cells and/or rebalancing reactors to facilitate ferrous iron reduction.

In one example, in order to effectively direct flow of hydrogen through the EHS system, the multi-chambered electrolyte storage tank 110 may be adapted with a tank-enclosed injector 86. A fluidic coupling of the tank-enclosed injector 86 to a main electrolyte circuit of the redox flow battery system 10 (e.g., where electrolyte is cycled between the redox flow battery cell 18, the rebalancing systems 80, 82, and the multi-chambered electrolyte storage tank 110) is generally indicated by dashed arrow 87. The dashed arrow 87 may also represent gas-phase fluidic coupling of the tank-enclosed injector 86 to areas of the redox flow battery system 10 prone to gas accumulation. As such, the tank-enclosed injector 86 may be included in an independent circuit separate from the main electrolyte circuit, with the independent circuit and the tank-enclosed injector 86 also being components of the EHS, in addition to the rebalancing systems 80, 82 and the multi-chambered electrolyte storage tank 110. Described another way, the independent circuit may be a first independent electrolyte circuit configured to divert electrolyte from the main electrolyte circuit, through the electrolyte storage tank 110 of the redox flow battery system. One or more pumps 84 may be included in the independent circuit to drive electrolyte flow through the tank-enclosed injector 86. The tank-enclosed injector 86 may be, for example, a venturi which may be completely enclosed within the head space 90 (and/or 92) of the multi-chambered electrolyte storage tank 110. By flowing electrolyte (e.g., positive or negative electrolyte) through the tank-enclosed injector 86, hydrogen gas may be drawn into the tank-enclosed injector 86 and channeled to a target destination with minimal backpressure. Further, even in an event of hydrogen leakage, the leakage may occur within the multi-chambered electrolyte storage tank 110, thereby mitigating escape of hydrogen from the redox flow battery system 10. Details of the tank-enclosed injector 86 are provided further below, with reference to FIGS. 2-6.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together.

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

Signals from the sensor 72, 70, and other sensors as described above, may be received by the controller. Furthermore, the controller 88 may send signals to actuators, such as valves and pumps, switches, etc., of the redox flow battery system 10. For example, sensor information may be transmitted to the controller 88, which may in turn actuate the pumps 30 and 32 to control electrolyte flow through the redox flow battery cell 18, or to perform other control functions, as an example. In this manner, the controller 88 may be responsive to one or a combination of sensors and probes.

In one example, the controller 88 may be configured with control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor. Further still, the change in pH or SOC triggering action of the controller 88 may be based on a rate of change or a change measured over a period. The time period for the rate of change may be predetermined or adjusted based on time constants for the redox flow battery system 10. For example, the period may be reduced if a recirculation rate is high, and local changes in concentration (e.g., due to side reactions or gas leaks) may quickly be measured since the time constants may be small.

As another example, the controller 88 may control charging and discharging of the redox flow battery cell 18 to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to increase a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing systems 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein) and may be part of the main electrolyte circuit of the redox flow battery system 10.

As described above, the rebalancing systems 80, 82 may include one or more of rebalancing reactors and rebalancing cells for facilitating reduction of ferric iron to ferrous iron using hydrogen in the presence of a catalyst. As further described herein with respect to FIGS. 2-3, in some embodiments of a tank-enclosed injection system, electrolyte may be delivered to a tank-enclosed venturi injector from a rebalancing cell. In another example, as shown in FIG. 4, electrolyte flow through a tank-enclosed venturi injector may discharge a two-phase flow comprising electrolyte and hydrogen gas, which may be directed to a rebalancing reactor. An example rebalancing cell is shown in FIGS. 7A and 7B, and an example of a rebalancing reactor is shown in FIG. 8.

Referring now to FIGS. 7A and 7B, a first perspective view 700 and a second perspective view 750 are shown, respectively, of a rebalancing cell 702 for a redox flow battery system, such as redox flow battery system 10 of FIG. 1. In an exemplary embodiment, the rebalancing cell 702 may include a stack of internally shorted electrode assemblies. The rebalancing cell 702 may enable an electrolyte rebalancing reaction to occur by allowing H₂ gas to contact an electrolyte from positive or negative electrode compartments of a redox flow battery, such as the redox flow battery cell 18 of FIG. 1, at catalytic surfaces of negative electrodes of the stack of internally shorted electrode assemblies. Accordingly, the rebalancing cell 702 may be one or both of the rebalancing systems 80 and 82 of FIG. 1. A set of reference axes 701 is provided for describing relative positioning of the components shown and for comparison between the views of FIGS. 7A-7B, the axes 701 indicating an x-axis, a y-axis, and a z-axis. As further shown in dashing in FIGS. 7A and 7B, an additional axis g may be parallel with a direction of gravity (e.g., in a positive direction along the axis g) and a vertical direction (e.g., in a negative direction along the axis g and opposite to the direction of gravity).

A number of the rebalancing cell 702 included in the redox flow battery system and a number of electrode assemblies included in the stack of internally shorted electrode assemblies are not particularly limited and may be increased to accommodate correspondingly higher performance applications. For example, a 75 KW redox flow battery system may include two rebalancing cells 702, each including a stack of 20 electrode assemblies (e.g., a stack of 19 bipolar assemblies with 2 endplates positioned at opposite ends of the stack).

As shown, the stack of internally shorted electrode assemblies may be removably enclosed within a housing or external cell enclosure 704. Accordingly, in some examples, the cell enclosure 704 may include a top cover removably affixed to an enclosure base, such that the top cover may be temporarily removed to replace or diagnose one or more electrode assemblies of the stack of internally shorted electrode assemblies. In additional or alternative examples, the cell enclosure 704, depicted in FIGS. 7A and 7B as a rectangular prism, may be molded to be clearance fit against other components of the redox flow battery system such that the rebalancing cell 702 may be in face-sharing contact with such components. In some examples, the cell enclosure 704 may be composed of a material having a low electrical conductivity, such as a plastic or other polymer, so as to reduce undesirable shorting events.

The cell enclosure 704 may further be configured to include openings or cavities for interfacial components of the rebalancing cell 702. For example, the cell enclosure 704 may include a plurality of inlet and outlet ports configured to fluidically couple to other components of the redox flow battery system. In one example, and as shown, the plurality of inlet and outlet ports may include polypropylene (PP) flange fittings fusion welded to PP plumbing.

In an exemplary embodiment, the plurality of inlet and outlet ports may include an electrolyte inlet port 706 for flowing the electrolyte into the cell enclosure 704 and an electrolyte outlet port 708 for expelling the electrolyte from the cell enclosure 704. In one example, the electrolyte inlet port 706 may be positioned on an upper half of the cell enclosure 704 and the electrolyte outlet port 708 may be positioned on a lower half of the cell enclosure 704 (where the upper half and the lower half of the cell enclosure 704 are separated along the z-axis by a plane parallel with each of the x- and y-axes). Accordingly, the electrolyte outlet port 708 may be positioned lower than the electrolyte inlet port 706 with respect to the direction of gravity (e.g., along the axis g).

Specifically, upon the electrolyte entering the cell enclosure 704 via the electrolyte inlet port 706, the electrolyte may be distributed across the stack of internally shorted electrode assemblies, gravity fed through the stack of electrode assemblies, wicked up (e.g., against the direction of gravity) through positive electrodes of the stack of internally shorted electrode assemblies to react at the catalytic surfaces of the negative electrodes in a cathodic half reaction, and expelled out of the cell enclosure 704 via the electrolyte outlet port 708. To assist in the gravity feeding of the electrolyte and decrease a pressure drop thereof, the rebalancing cell 702 may further be tilted or inclined with respect to the direction of gravity via a sloped support 720 coupled to the cell enclosure 704. In some examples, tilting of the cell enclosure 704 in this way may further assist in electrolyte draining of the rebalancing cell 702 (e.g., during an idle mode of the redox flow battery system) and keep the catalytic surfaces relatively dry (as the catalytic surfaces may corrode after being soaked in the electrolyte for a sufficient duration, in some examples).

As shown, the sloped support 720 may tilt the cell enclosure 704 at an angle 722 such that planes of electrode sheets of the stack of internally shorted electrode assemblies are inclined with respect to a lower surface (not shown) on which the sloped support 720 rests at the angle 722. In some examples, the angle 722 (e.g., of the cell enclosure 704 with respect to the lower surface) may be between 0° and 30° (in embodiments wherein the angle 722 is substantially 0°, the rebalancing cell 702 may still function, though the pressure drop may be greater and electrolyte crossover to the negative electrodes may be reduced when the cell enclosure 704 is tilted). In some examples, the angle 722 may be between 2° and 30°. In some examples, the angle 722 may be between 2° and 20°. In one example, the angle 722 may be about 8°. Accordingly, the pressure drop of the electrolyte may be increased by increasing the angle 722 and decreased by decreasing the angle 722. Additionally or alternatively, one or more support rails 724 may be coupled to the upper half of the cell enclosure 704 (e.g., opposite from the sloped support 720). In some examples, and as shown in the perspective view 700 of FIG. 7A, the one or more support rails 724 may be tilted with respect to the cell enclosure 704 at the angle 722 such that the one or more support rails 724 may removably fasten the rebalancing cell 702 to an upper surface above and parallel with the lower surface. In this way, and based on geometric considerations, the z-axis may likewise be offset from the axis g at the angle 722 (e.g., the cell enclosure 704 may be tilted with respect to a vertical direction opposite the direction of gravity by the angle 722, as shown in FIGS. 7A and 7B). In some examples, gravity feeding of the electrolyte through the rebalancing cell 702 may further be assisted by positioning the rebalancing cell 702 above an electrolyte storage tank (e.g., the multi-chambered electrolyte storage tank 110 of FIG. 1) of the redox flow battery system with respect to the vertical direction opposite to the direction of gravity.

As further shown, the electrolyte outlet port 708 may include a plurality of openings in the cell enclosure 704 configured to expel at least a portion of the electrolyte (each of the plurality of openings including the PP flange fitting fusion welded to PP plumbing). For instance, in FIGS. 7A and 7B, the electrolyte outlet port 708 is shown including five openings. In this way, the electrolyte may be evenly distributed across the stack of internally shorted electrode assemblies and may be expelled from the cell enclosure 704 with substantially unimpeded flow. In other examples, the electrolyte outlet port 708 may include more than five openings or less than five openings. In one example, the electrolyte outlet port 708 may include only one opening. In additional or alternative examples, the electrolyte outlet port 708 may be positioned beneath the cell enclosure 704 with respect to the z-axis (e.g., on a face of the cell enclosure 704 facing a negative direction of the z-axis).

The electrolyte inlet port 706 and the electrolyte outlet port 708 may be positioned on the cell enclosure 704 based on a flow path of the electrolyte through the stack of internally shorted electrode assemblies (e.g., from the electrolyte inlet port 706 to the electrolyte outlet port 708 and inclusive of channels, passages, plenums, wells, etc. within the cell enclosure 704 fluidically coupled to the electrolyte inlet port 706 and the electrolyte outlet port 708). In some examples, and as shown, the electrolyte inlet port 706 and the electrolyte outlet port 708 may be positioned on adjacent sides of the cell enclosure 704 (e.g., faces of the cell enclosure 704 sharing a common edge). In other examples, the electrolyte inlet port 706 and the electrolyte outlet port 708 may be positioned on opposite sides of the cell enclosure 704. In other examples, the electrolyte inlet port 706 and the electrolyte outlet port 708 may be positioned on the same side of the cell enclosure 704.

In some examples, the electrolyte inlet port 706 may be positioned on a face of the cell enclosure 704 facing a negative direction of the x-axis. In additional or alternative examples, the electrolyte inlet port 706 may be positioned on a face of the cell enclosure 704 facing a positive direction of the x-axis. In one example, and as shown, one opening of the electrolyte inlet port 706 may be positioned on the face of the cell enclosure 704 facing the negative direction of the x-axis and another opening of the electrolyte inlet port 706 may be positioned on the face of the cell enclosure 704 facing the positive direction of the x-axis.

In some examples, the plurality of inlet and outlet ports may further include a hydrogen gas inlet port 710 for flowing the H₂ gas into the cell enclosure 704 and a hydrogen gas outlet port 712 (as shown in FIG. 7B) for expelling the H₂ gas from the cell enclosure 704. In one example, and as shown, each of the hydrogen gas inlet port 710 and the hydrogen gas outlet port 712 may be positioned on the lower half of the cell enclosure 704 (e.g., at a lowermost electrode assembly of the stack of internally shorted electrode assemblies along the z-axis). In another example, each of the hydrogen gas inlet port 710 and the hydrogen gas outlet port 712 may be positioned on the upper half of the cell enclosure 704 (e.g., at an uppermost electrode assembly of the stack of internally shorted electrode assemblies along the z-axis). In yet another example, the hydrogen gas inlet port 710 may be positioned on the lower half of the cell enclosure 704 and the hydrogen gas outlet port 712 may be positioned on the upper half of the cell enclosure 704. In such an example, the hydrogen gas inlet port 710 may be positioned lower than the hydrogen gas outlet port 712 with respect to the direction of gravity (e.g., along the axis g).

Specifically, upon the H₂ gas entering the cell enclosure 704 via the hydrogen gas inlet port 710, the H₂ gas may be distributed across and through the stack of internally shorted electrode assemblies via forced convection (e.g., induced by flow field configurations of respective flow field plates) and decomposed at the catalytic surfaces of the negative electrodes in an anodic half reaction. However, in some examples, excess, unreacted H₂ gas may remain in the rebalancing cell 702 following contact with the catalytic surfaces. In some examples, at least a portion of the H₂ gas which has not reacted at the catalytic surfaces may pass into the electrolyte. To avoid undesirable pressure buildup and thereby prevent electrolyte pooling on the positive electrodes and concomitant electrolyte flooding of the negative electrodes in such examples, the plurality of inlet and outlet ports may further include a pressure release outlet port 714 to expel unreacted H₂ gas from the electrolyte. Further, in some examples, the hydrogen gas outlet port 712 may be configured to expel at least a portion of the H₂ gas which has not reacted at the catalytic surfaces and that has not flowed through the negative electrodes into the electrolyte.

The hydrogen gas inlet port 710 and the hydrogen gas outlet port 712 may be positioned on the cell enclosure 704 based on a flow path of the H₂ gas through the stack of internally shorted electrode assemblies [e.g., from the hydrogen gas inlet port 710 to the hydrogen gas outlet port 712 (when included) and inclusive of channels, passages, plenums, etc. within the cell enclosure 704 fluidically coupled to the hydrogen gas inlet port 710 and the hydrogen gas outlet port 712 (when included)]. In some examples, and as shown, the hydrogen gas inlet port 710 and the hydrogen gas outlet port 712 may be positioned on opposite sides of the cell enclosure 704. In other examples, the hydrogen gas inlet port 710 and the hydrogen gas outlet port 712 may be positioned on adjacent sides of the cell enclosure 704. In other examples, the hydrogen gas inlet port 710 and the hydrogen gas outlet port 712 may be positioned on the same side of the cell enclosure 704. Further, though the hydrogen gas inlet port 710 is shown in FIGS. 7A and 7B as being positioned on the face of the cell enclosure 704 facing the negative direction of the x-axis and the hydrogen gas outlet port 712 is shown in FIGS. 7A and 7B as being positioned on the face of the cell enclosure 704 facing the positive direction of the x-axis, in other examples, the hydrogen gas inlet port 710 may be positioned on the face of the cell enclosure 704 facing the positive direction of the x-axis and the hydrogen gas outlet port 712 may be positioned on the face of the cell enclosure 704 facing the negative direction of the x-axis.

In one example, the hydrogen gas inlet port 710, the hydrogen gas outlet port 712, the electrolyte inlet port 706, and the electrolyte outlet port 708 may be positioned on the cell enclosure 704 in a crosswise configuration. Specifically, the crosswise configuration may include the hydrogen gas outlet port 712 and the electrolyte inlet port 706 being positioned on different sides (e.g., faces) of the upper half of the cell enclosure 704 and the hydrogen gas inlet port 710 and the electrolyte outlet port 708 being positioned on different sides of the lower half of the cell enclosure 704.

In other examples, no hydrogen gas outlet port 712 may be present for expelling H₂ gas which has not reacted at the catalytic surfaces of the negative electrodes and which has not flowed through the negative electrodes into the electrolyte. In such examples, however, the pressure release outlet port 714 for expelling unreacted H₂ gas from the electrolyte may still be present, and the unreacted H₂ gas may only be expelled from the cell enclosure 704 after flowing through the negative electrodes into the electrolyte and through the pressure release outlet port 714. Exemplary rebalancing cell configurations lacking the hydrogen gas outlet port 712, whether or not including the pressure release outlet port 714, may be referred to as “dead ended configurations.” In dead ended configurations, substantially all of the H₂ gas may be forced into contact with the catalytic surfaces of the negative electrodes, whereat the H₂ gas may either decompose via the anodic half reaction and/or the H₂ gas may enter the electrolyte after passing through the negative electrodes (e.g., without reacting at catalytic surfaces thereof).

In FIG. 8, an example of a catalyst bed 800 is shown. As one example, the catalyst bed 800 may include a rebalancing cell. The catalyst bed 800 may be formed by coating a substrate layer 804 with a catalyst layer 806. One or both sides of the substrate layer 804 may be coated with the catalyst layer 806. Coating both sides of the substrate layer 804 may increase a redox reaction rate of the catalyst bed 800 as compared to coating a single side of the substrate layer 804. A set of reference axes 801 is provided for describing relative positioning of the components shown, the axes 801 indicating an x-axis, a y-axis, and a z-axis.

Substrate layer 804 may include a flexible and bendable substrate such as carbon cloth, carbon paper, or another type of membrane. Substrate layer 804 may be porous or non-porous, and/or permeable to hydrogen gas, hydrogen ions, and to electrolyte, such as positive electrolyte and negative electrolyte from positive electrolyte chamber 52 and negative electrolyte chamber 50 of FIG. 1. Substrate layer 804 may further be inert with respect to hydrogen gas, hydrogen ions, and the electrolyte including both the positive electrolyte and the negative electrolyte. A thickness 808 of the substrate layer 804 may be small enough so as not to substantially hinder diffusion or convective transport of electrolyte species through the substrate layer 804. For example, when the substrate layer 804 is thinner than 0.5 mm, reaction rates may be higher as compared to when the substrate layer 804 is thicker than 0.5 mm.

The substrate layer 804 may be conductive, semi-conductive, or non-conductive. Conductive substrate layers may yield higher reaction rates as compared to non-conductive substrate layers. For example, a carbon substrate (e.g., carbon cloth, carbon paper, and the like) may aid in electron transfer, and provides a catalytic surface for the ferric/ferrous ion redox reaction. Some example membrane materials that may be utilized for the substrate layer 804 include polypropylene, polyolefin, perfluoroalkoxy (PFA), polysulfone amide (PSA), and the like. In addition, the substrate layer 804 may comprise a thin ceramic sheet or a thin metal sheet, provided the substrate layer 804 does not react with ferric ions.

Catalyst layer 806 may include one or more different types of catalyst materials such as platinum, palladium, ruthenium, alloys thereof. The weight percent of the catalyst material on the substrate layer 804 may be from 0.2 wt % to greater than 0.5 wt %. The substrate layer 804 coated with the catalyst layer 806 may be porous and permeable to hydrogen gas, hydrogen ions, and to electrolyte including the positive electrolyte and the negative electrolyte. When hydrogen gas and metal ions in the electrolyte are fluidly contacted at the catalyst layer 806, the catalyst layer 806 may catalyze a redox reaction whereby the hydrogen gas may be oxidized to hydrogen ions and the metal ions may be reduced. The substrate layer 804 may be coated entirely with the catalyst layer 806 to increase a redox reaction rate of hydrogen gas and metal ions at the catalyst layer surface.

Catalyst bed 800 may further comprise a spacing layer 810 positioned on the catalyst layer. As shown in FIG. 8, the spacing layer 810 may be thinner than the substrate layer 804, however in other examples, the substrate layer 804 may be thinner than the spacing layer 810. Thinner spacing layers may yield higher catalyst bed reaction rates with higher pressure drops across the catalyst bed while thicker spacing layers may yield lower reaction rates with lower pressure drops across the catalyst bed. In some examples the spacing layer 810 may be less than 1 mm thick. The spacing layer 810 may comprise a mesh, such as a plastic or other type of non-conductive mesh. For example, the spacing layer may comprise a polypropylene, polyolefin, polyethylene, polystyrene, or other polymer mesh that is stable (e.g., does not react with or degrade in the presence of) ferric/ferrous ion solutions. In other examples, the spacing layer may comprise and open-celled plastic foam or sponge material.

A conductive wire 830 may be woven through the catalyst layer 806 so that the conductive wire 830 is in close proximity to the catalyst material, e.g., in contact with or near catalyst sites. The conductive wire 830 may have a linear, sinuous, zig zag, etc. layout across the z-x plane in the catalyst layer 806 and extend out of the catalyst bed 800 to couple to an electrical energy storage device 832, hereafter battery 832. A voltage supplied by the battery 832 may be conducted to the catalyst layer 806 via the conductive wire 830.

The catalyst bed 800 may be spiral wound to form a jelly roll structured catalyst bed 820. Each successive substrate layer 804 and catalyst layer 806 of the spiral wound jelly roll structured catalyst bed 820 is separated by the spacing layer 810. The spacing layer 810 may entirely cover the catalyst layer 806. In this way, each catalyst layer 806 is entirely separated from an adjacent catalyst layer by the spacing layer 810 when the substrate layer 804 is coated on both sides by the catalyst layer 806. The spacing layers 810 may extend across the entire axial dimension, e.g., along the y-axis, of the jelly roll structured catalyst bed 820, as indicated by dashed lines.

When coiled into the jelly roll structure as shown in FIG. 8, the jelly roll structured catalyst bed 820 has a cylindrical shape. The cylindrical, rolled configuration of the jelly roll structured catalyst bed 820 may allow the jelly roll structured catalyst bed 820 to be removed as a single unit, reducing time and costs of maintenance of a rebalancing reactor. Electrolyte may be flowed through the jelly roll structured catalyst bed 820, the flow in contact with the catalyst bed 820 for a prolonged period of time in comparison to packed catalyst beds, increasing an efficiency of the jelly roll structured catalyst bed 820 in facilitating hydrogen oxidation and iron reduction, thus operating as a rebalancing reactor.

The conductive wire 830 may be incorporated into the catalyst layer 806 so that ends of the conductive wire 830 that couple directly to the battery 832 extend out of the jelly roll structured catalyst bed 820 in an axial direction, along the y-axis. The jelly roll structure catalyst bed 820 may be inserted into an outer housing that is also cylindrical to match a shape of the jelly roll structure catalyst bed 820, sliding in and out of the housing along a central axis of rotation of the cylindrical outer housing. Extension of the conductive wire 830 from a top or a bottom, with respect to the y-axis, of the jelly roll structure catalyst bed 820 allows the conductive wire 830 to be readily connected to the battery 832 through a top or a bottom of the outer housing of the jelly roll structured catalyst bed 820.

As described above, hydrogen gas may be circulated within a battery system, including between a head space of an electrolyte tank, such as gas head spaces 90 and 92 of FIG. 1, and components of the redox flow battery that demand hydrogen, such as electrolyte rebalancing systems 80 and 82. Conventionally, hydrogen flow may be driven by a system relying on injectors arranged in a path of hydrogen flow, external to components of the EHS. The injectors may be prone to leakage, due at least in part to incorporation of various mechanical connectors through which hydrogen gas may escape if not rigorously sealed. Further, a tendency for back pressure to be generated at an outlet of the injectors may exacerbate a likelihood of leakage. In some instances, larger pumps may be demanded to compensate for loss of gas flow due to leakage, which may increase a parasitic power demand.

To address these issues, at least one injector may be enclosed within the electrolyte tank. In one example, electrolyte flow through the injector may draw hydrogen gas through the injector, which may discharge a mixture of electrolyte and gas directly into the head space of the electrolyte tank or the mixture may be directed to another component of the EHS. The injector may be configured to receive single phase (e.g., exclusively electrolyte) flow and discharge two-phase (e.g., a mixture of electrolyte and hydrogen) flow and may be fluidically coupled to the head space of the electrolyte tank at either a suction port or an outlet of the injector. In other words, the injector may either draw gas from a head space of the electrolyte tank or eject fluid into the electrolyte tank. The tank-enclosed injector disclosed herein may reduce leakage by allowing fluid to be freely discharged into the electrolyte tank and/or drawn to another EHS components based on electrolyte flow, thereby minimizing backpressure at the injector outlet. Pumps used to drive hydrogen flow may be decreased in size, or, in some examples, precluded. As a result, servicing and associated maintenance costs of the battery system may be reduced while system efficiency may be increased.

Referring now to FIG. 2, a first example of a tank-enclosed injection system 200 with at least one venturi injector 212 is illustrated, where the venturi injector 212 is an example of the tank-enclosed injector 86 of FIG. 1. The tank-enclosed injection system 200 may be included in an EHS of a redox flow battery system, such as the redox flow battery system 10 of FIG. 1. A coordinate system 201 including an x-axis, y-axis, and z-axis is provided. In one example, the y-axis may be parallel with a direction of gravity while the x-z plane may be coplanar with a horizontal plane perpendicular to the direction of gravity. As shown in FIG. 2, the tank-enclosed injection system 200 includes an electrolyte tank 202 having a reservoir 204 and a tank hatch or manway 206. In one example, the electrolyte tank 202 may be an embodiment of the multi-chambered electrolyte storage tank 110 of FIG. 1. However, in other examples, the electrolyte tank 202 may be an additional electrolyte storage tank included in the redox flow battery system, such as a secondary storage tank. The secondary storage tank may be fluidically coupled to a main electrolyte storage tank such that electrolyte flows through the main and secondary storage tanks in series, or may be arranged in an electrolyte circuit in parallel with a main electrolyte circuit of the redox flow battery system. The electrolyte tank 202 includes a head space 208 and a fill height (or liquid interface) 210. Similar to the example given in FIG. 1, H₂ may separate spontaneously at the liquid interface 210, filling the head space 208.

The venturi injector 212 may be mechanically coupled to the tank manway 206 such that the venturi injector 212 may be suspended within the head space 208 above the liquid interface 210. In other examples, however, the venturi injector 212 may be maintained suspended above the liquid interface 210 in a manner other than by coupling to the tank manway 206. For example, the venturi injector 212 may instead be mechanically coupled to an upper region of the reservoir 204 of the electrolyte tank 202, or supported by structures extending upwards from a lower region of the electrolyte tank 202, etc.

A central axis 228 of the venturi injector 212 may be oriented parallel with the x-axis and aligned with a direction of liquid flow through the venturi injector 212, which may be a flow of electrolyte. The electrolyte flow, as indicated by arrow 236, may be delivered to an inlet 218 of the venturi injector 212 via an electrolyte passage 214 extending between a first port 203 of the tank manway 206 and the inlet 218, within the electrolyte tank 202. The first port 203 may extend through an entire thickness of the tank manway 206, forming an opening therethrough. To accommodate an orientation of the venturi injector 212, the electrolyte passage 214 may have a 90-degree bend, although other configurations of the electrolyte passage 214 are possible. At the first port 203, the electrolyte passage 214 may be coupled to an external electrolyte passage that fluidically couples the electrolyte tank 202 to an electrolyte source, such as a rebalancing cell, through which the electrolyte may be circulated. For example, the electrolyte passage 214 may be coupled to the electrolyte outlet port 708 of the rebalancing cell 702 of FIGS. 7A and 7B.

A flow of gas, such as hydrogen gas, is indicated by arrow 232, and may be delivered to a suction port 220 of the venturi injector 212 via a gas passage 216. For example, gas may enter the venturi injector 212 in a direction perpendicular to the flow of the electrolyte therethrough. Further, the inlet 218 of the venturi injector 212 may be arranged at an end of the venturi injector 212 along a length of the venturi injector 212, where the length is parallel to the central axis 228, whereas the suction port 220 of the venturi injector 212 may be arranged at a mid-point along the length of the venturi injector 212. More specifically, the suction port 220 may be aligned with a constriction 224 of the venturi injector 212. The constriction 224 may be a central region of the venturi injector 212, relative to its length, but may or may not be at an actual central point of the venturi injector 212 relative to its length. For example, the constriction 224 may be biased to be closer to an outlet 222 than the inlet 218 of the venturi injector 212. A diameter of the venturi injector 212 may be narrowed at the constriction 224 relative to the inlet 218 and the outlet 222 of the venturi injector 212, thereby forming a throat. The diameter of the venturi injector 212 at the inlet 218 may be similar to or different from the diameter of the venturi injector 212 at the outlet 222.

The gas passage 216 may extend between a second port 205 of the tank manway 206 and the suction port 220 within the electrolyte tank 202 and the gas passage 216 may be coupled to an external gas passage at the second port 205. Similar to the first port 203, the second port 205 may extend through the entire thickness of the tank manway 206 to form an opening therethrough. The external gas passage may fluidically couple the electrolyte tank 202 to an external gas source, which may include one or more regions of the redox battery system in which hydrogen gas generated as a byproduct may accumulate.

At the outlet 222 of the venturi injector 212, the outlet 222 located at an opposite end of the venturi injector 212 from the inlet 218, two-phase flow comprising a mixture of liquid (e.g., electrolyte) and gas (e.g., hydrogen) may be ejected from the venturi injector 212 into an interior of the electrolyte tank 202, as indicated by arrows 230. The mixture may spontaneously separate upon discharge from the venturi injector 212 and the liquid may be collected in the reservoir 204 of the electrolyte tank 202 while the gas may be collected in the head space 208.

In one example, the external electrolyte passage may direct electrolyte flow from the rebalancing cell to the venturi injector 212 via the electrolyte passage 214. For example, electrolyte that has been treated by the rebalancing cell (e.g., catalytic ferrous iron reduction) may be pumped into the electrolyte tank and stored therein for subsequent recirculation to a rebalancing reactor or a battery cell of the redox flow battery system. Hydrogen may be drawn into the venturi injector 212 by suction created by a pressure differential. The pressure differential may result from electrolyte flow through the constriction 224 as electrolyte is pumped into the venturi injector 212. For example, as the electrolyte flowing through the venturi injector 212 encounters the constriction 224, flow therethrough is restricted, forcing an increase in flow velocity through the constriction 224 and forming a zone of low pressure downstream of the constriction 224, at the outlet 222. The zone of low pressure may create suction that draws hydrogen into and through the venturi injector 212 via the suction port 220.

The venturi injector 212 may therefore be mechanically coupled to the tank manway 206 via the electrolyte passage 214, the first port 203, the gas passage 216, and the second port 205. The electrolyte tank 202 may be sealed against exchange of gas or liquid between the interior of the electrolyte tank 202 and outside (e.g., exterior) of the electrolyte tank 202 via interfacing structures, such as flanges. Furthermore, couplings between various passages of the tank-enclosed injection system 200 may be similarly sealed using flanges, as shown in FIG. 3. By attaching the venturi injector 212 to the tank manway 206, the venturi injector 212 may be readily accessed for removal, inspection, and/or maintenance without demanding decoupling of the electrolyte and gas passages. For example, by detaching the tank manway 206 from the reservoir 204 of the electrolyte tank 202 the venturi injector 212, along with the electrolyte passage 214, the gas passage 216, and corresponding fittings and connectors may be concurrently detached from the reservoir 204 as a single unit.

Referring now to FIG. 3, a second example of a tank-enclosed injection system 300 for an EHS of a redox flow battery system is illustrated. The tank-enclosed injection system 300 includes the electrolyte tank 202 with the reservoir 204, the tank manway 206, the head space 208, and the liquid interface 210 of FIG. 2. A venturi injector 312 may also be coupled to the tank manway 206 with a central axis 328 of the venturi injector 312 oriented parallel with the y-axis. For example, the venturi injector 312 may be oriented perpendicular to the venturi injector 212 of FIG. 1. The tank manway 206 has a first port 303 and a second port 305 extending through the tank manway 206, similar to the first port 203 and the second port 205 of FIG. 2. As described above, each of the first port 303 and the second port 305 may be sealed using flanges or other sealing devices or structure. An electrolyte passage 314 extends between the first port 303 and an inlet 318 of the venturi injector 312, where a portion of the electrolyte passage 314 may protrude through the first port 303 outside of the electrolyte tank 202. A gas passage 316 extends between the second port 305 and a suction port 320 of the venturi injector 312, where a portion of the gas passage 316 may protrude through the second port 305, outside of the electrolyte tank 202. The suction port 320 may be located proximate to a constriction 324 of the venturi injector 312.

The venturi injector 312 has an outlet 322 at an opposite end of the venturi injector 312 from the inlet 318. As described above, a diameter of the venturi injector 312 may be narrowest at the constriction 324 and may widen at each of the inlet 318 and the outlet 322, which may or may not be similar in diameter. The constriction 324 is located at a central portion of the venturi injector 312 along the central axis 328, between the inlet 318 and the outlet 322. The venturi injector 312 may operate analogously to the venturi injector 212 of FIG. 2, except that the venturi injector 312 has a vertical orientation whereas the venturi injector 212 has a horizontal orientation. To accommodate a configuration of the venturi injector 312, the electrolyte passage 314 may be linear while the gas passage 316 may include a 90-degree bend.

An external electrolyte passage may be coupled to the electrolyte passage 314 at an interface sealed by a first flange 330 and the electrolyte passage 314 may be coupled to the inlet 318 of the venturi injector 312 at an interface sealed by a second flange 331. The external electrolyte passage may deliver electrolyte to the venturi injector 312 from a rebalancing cell, as indicated by arrow 332. For example, the electrolyte passage 314 may be coupled to the electrolyte outlet port 708 of the rebalancing cell 702 of FIGS. 7A and 7B. An external gas passage may couple to the gas passage 316 at an interface sealed by a third flange 334 to deliver gas to the venturi injector 312, as indicated by arrow 336, from regions of the redox flow battery system where hydrogen accumulates. It will be appreciated that the first, second, and third flanges 330, 331, and 334 may be similarly used in the first example of the tank-enclosed injection system 200 of FIG. 2.

Similar to the example given in FIG. 2, the constriction 324 produces a Venturi effect, where a flow velocity through the constriction 324 increases relative to the inlet 318 due to a resistance to flow imposed by the constriction 324. A resulting drop in pressure across the constriction 324 (e.g., lower pressure at the outlet 322 relative to the inlet 318 of the venturi injector 312) draws gas into the venturi injector 312 through the suction port 320. The gas may mix with the electrolyte in the outlet 322 and be ejected, as indicated by arrows 338, into the head space 208 of the electrolyte tank 202 as a mixture. As described above, with reference to FIG. 2, the mixture is discharged freely, without resistance, thereby precluding generation of backpressure at the outlet 322 of the venturi injector 312. The mixture separates upon ejection into liquid collected in the reservoir 204 and into gas collected in the head space 208.

The examples of FIGS. 2 and 3 show two different orientations for the venturi injector that enables leveraging of electrolyte flow from the rebalancing cell to drive extraction and collection of byproduct hydrogen into the electrolyte tank. It will be appreciated that the embodiments shown in FIGS. 2, 3, and 4 (as described further below) are non-limiting examples and other arrangements of the venturi injector within the electrolyte tank are possible without departing from the scope of the present disclosure. Furthermore, elements that vary between the embodiments (e.g., orientations, connectors and couplings, etc.) shown may be included in different combinations amongst the various possible configurations of the tank-enclosed injection systems, in other examples. In addition, the electrolyte tank may be adapted with more than one venturi injector, which may or may not be similarly configured. As one example, as shown in FIG. 4, the electrolyte tank may include a venturi injector configured to deliver gas (e.g., hydrogen) from the head space of the electrolyte tank to a rebalancing reactor.

Referring now to FIG. 4, a third example of a tank-enclosed injection system 400 is shown. The tank-enclosed injection system 400 includes the electrolyte tank 202 of FIGS. 2 and 3, including the reservoir 204, the tank manway 206, the head space 208, and the liquid interface 210. A venturi injector 412 may be coupled to the tank manway 206, suspended above the liquid interface 210 with a central axis 428 of the venturi injector 412 oriented parallel with the x-axis. However, in other examples, the venturi injector 412 may have an alternate orientation. As described above, the venturi injector 412 has an inlet 418 and an outlet 422 opposite the inlet 418, and a constriction 424 at a central region of the venturi injector 412, between the inlet 418 and the outlet 422.

A first port 403 may form an opening through the tank manway 206 and allow an external electrolyte passage to be coupled to an electrolyte passage 414 extending between the first port 403 and the inlet 418 of the venturi injector 412. The electrolyte passage 414 may be coupled to the external electrolyte passage at one end by a first flange 404 and may also be coupled to the inlet 418 of the venturi injector 412 at an opposite end by a flange or some other sealing structure (not shown in FIG. 4). Electrolyte from an electrolyte source, may be delivered to the venturi injector 412 through the first port 403 and the electrolyte passage 414. As an example the electrolyte may be diverted from a main electrolyte circuit of the redox flow battery system.

A fluid passage 416 may extend between the outlet 422 of the venturi injector 412 and a second port 405 forming an opening in the tank manway 206. The fluid passage 416 may be coupled at one end to the outlet 422 of the venturi injector 412 by a flange or some other sealing structure (not shown in FIG. 4) and coupled at an opposite end to an external fluid passage by a second flange 406. The external fluid passage may fluidically couple the venturi injector 412 to a rebalancing reactor. The venturi injector 412 may therefore be mechanically coupled to the tank manway 206 by the first port 403, the electrolyte passage 414, the second port 405, and the fluid passage 416. Each of the electrolyte passage 414 and the fluid passage 416 may include a 90-degree bend to accommodate a horizontal arrangement (e.g., with the central axis 428 aligned with the x-axis) of the venturi injector 412.

The venturi injector 412 further includes a suction port 420 located at the constriction 424, where a diameter of the venturi injector 412 is narrower at the constriction 424 than at the inlet 418 or the outlet 422. In contrast to the venturi injectors of FIGS. 2 and 3, the suction port 420 is not coupled to a passage directing gas from a gas source. Instead, the suction port 420 is open to the head space 208 of the electrolyte tank 202. As the electrolyte flows into the inlet 418 of the venturi injector 412, as indicated by arrow 430, and a low pressure zone is formed downstream of the constriction 424 in the venturi injector 412, gas from the head space 208 is drawn into the venturi injector 412 through the suction port 420, as indicated by arrow 432. The gas and the electrolyte are mixed in the outlet 422 of the venturi injector 412 and discharged into and through the fluid passage 416 in a direction indicated by arrow 434. For example, the gas and electrolyte may be discharged to and flowed through the jelly roll structured catalyst bed 820 of FIG. 8.

The venturi injector 412 therefore receives a one-phase flow (e.g., exclusively electrolyte) from outside of the electrolyte tank 202 and discharges a two-phase flow (e.g., a mixture of hydrogen and electrolyte) to a destination also outside of the electrolyte tank 202. The electrolyte flowing through the venturi injector 412 is transported through a circuit that is sealed with respect to an interior of the electrolyte tank 202. In other words, electrolyte flowing through the venturi injector 412 does not exchange with electrolyte in the electrolyte tank 202. The hydrogen that is entrained into the electrolyte flow through the venturi injector 412 may serve as an electron donor for electrolyte rebalancing when the two-phase flow is delivered to the rebalancing reactor.

As described herein, the electrolyte tank may be adapted with more than one venturi injector, which may or may not be similarly configured. For example, the electrolyte tank may include a first injector positioned in a first independent electrolyte circuit and a second injector positioned in a second independent electrolyte circuit. The first independent electrolyte circuit is configured to divert electrolyte from the main electrolyte circuit through an electrolyte tank of the redox flow battery system. The first independent electrolyte circuit may include at least one injector. For example, the first injector has an inlet for receiving electrolyte flow and a suction port for receiving hydrogen, wherein the electrolyte and the hydrogen are mixed in an outlet of the at least one injector prior to discharge from the at least one injector. The first injector may be an example of the venturi injector 212 of FIG. 2, and/or the venturi injector 312 of FIG. 3. At least one injector of the first independent electrolyte circuit is fluidically coupled to a rebalancing cell and configured to deposit a mixture of electrolyte and hydrogen into the electrolyte tank. The second independent electrolyte circuit is configured to deliver a mixture of electrolyte and hydrogen to a rebalancing reactor, the hydrogen obtained from a head space of the electrolyte tank. The second injector is also arranged in the electrolyte tank, and is configured to deliver a mixture of electrolyte and hydrogen to a rebalancing reactor, the hydrogen obtained from a head space of the electrolyte tank. The second injector may be an example of the venturi injector 412 of FIG. 4. In this way, electrolyte may be cycled through both the rebalancing reactor and the rebalancing cell, which may further increase an efficiency of the redox flow battery system by increasing a capacity of electrolyte replenishing systems.

A tank-enclosed injection system of an EHS may therefore include an electrolyte tank adapted to support location of one or more venturi injectors within a head space of the electrolyte tank. In one example, the tank-enclosed injection may incorporate one or more of a first venturi injector that relies on electrolyte flow therethrough to draw and discharge both electrolyte and hydrogen into the electrolyte tank, as shown in FIGS. 2 and 3, and/or one or more of a second venturi injector that depends on electrolyte flow therethrough to suck hydrogen from the head space of the electrolyte tank and mix the hydrogen into the electrolyte flow, as shown in FIG. 4. The first venturi injector may aid in pulling hydrogen into electrolyte tank from a redox flow battery system while the second venturi injector may aid in delivering hydrogen to a rebalancing reactor. By incorporating at least one of the first and second venturi injectors, electrolyte rebalancing efficiency may be increased without incurring higher energy consumption. As described above, leakage of hydrogen is reduced by an ability to enclose gas fittings, connectors, and seals within the electrolyte tank. In an event of a gas leak, the gas may escape to the head space of the electrolyte tank, rather than to ambient surroundings. Fittings, connectors, and seals arranged exterior of the electrolyte tank may be specifically directed to single-phase liquid flow or two-phase flow (liquid and gas), which allows leakage at such structures to be readily detected.

Flow of gas into the venturi injectors may be depend on a rate of electrolyte flow, which, in turn may be controlled by operation of one or more pumps and also by a pipe diameter of corresponding electrolyte passages. As an example, for the embodiments of FIGS. 2 and 3, a pump (or pumps) with a variable frequency drive (VFD) may be used to drive electrolyte flow to the venturi injector. The flow rate of hydrogen to the venturi injector may be proportional to the electrolyte flow rate. For the embodiment of FIG. 4, the suction of hydrogen into the venturi injector may be similarly dependent on a speed at which the electrolyte is pumped into the venturi injector through the electrolyte passages, as well as a diameter of the electrolyte passages.

Examples of methods 500 and 600 for controlling gas flow through an EHS of a redox flow battery system are shown in FIGS. 5 and 6, respectively. Method 500 may be used for a tank-enclosed injection system as shown in FIGS. 2 and 3, where electrolyte is flowed from a rebalancing cell to an injector (e.g., a venturi) of the tank-enclosed injection system and hydrogen is drawn from hydrogen-collecting zones of the redox flow battery system. Method 600 may be used for a tank-enclosed injection system as shown in FIG. 4, where electrolyte is flowed through an injector (e.g., a venturi) to entrain hydrogen from a head space of an electrolyte tank and a resulting two-phase flow is delivered to a rebalancing reactor. At least some processes in methods 500 and 600 may be executed by a controller, such as the controller 88 of FIG. 1, based on instructions stored on a non-transitory memory of the controller. For example, the controller may be configured with instructions to acquire data from various sensors of the redox flow battery system and adjust actuators of the redox flow battery system, as described above with reference to FIG. 1.

Turning first to FIG. 5, at 502, method 500 includes operating one or more electrolyte pumps to drive electrolyte flow through the EHS. For example, operating the electrolyte pumps may include the controller commanding activation, e.g., energization, of the electrolyte pumps to promote circulation of electrolyte through a first independent circuit that is fluidically coupled to a main electrolyte circuit of the redox flow battery system. Further, a pipe diameter of passages of the first independent circuit may be sized to provide a desired electrolyte and hydrogen flow rate, in conjunction with a pumping rate of the electrolyte pumps. The injector in the electrolyte tank and at least one rebalancing cell is included in the first independent circuit. The main electrolyte circuit may include components of the redox flow battery system such as battery cells, at least one electrolyte tank, as well as one or more rebalancing reactors (which may also be included in the EHS), in some examples. The first independent circuit may divert at least a portion of the electrolyte from the main electrolyte circuit to deliver the portion of the electrolyte to the rebalancing cell. The first independent circuit may also include gas passages coupled to areas of the main electrolyte circuit that serves as a gas accumulation and/or gas storage area in which hydrogen generated as a byproduct of redox reactions at the battery cells may be collected.

By driving electrolyte flow through the first independent circuit, the electrolyte may flow through at least one rebalancing cell located upstream of the injector and into the electrolyte tank at 504 of method 500, via the injector disposed therein. As the electrolyte flows through the injector, suction is created which draws hydrogen through the gas passages of the first independent circuit and into the injector. The injector is mixed with the electrolyte at an outlet of the electrolyte and discharged into the electrolyte tank. Method 500 returns to the start.

Turning now to FIG. 6, at 602, method 600 includes estimating and/or measuring a condition of the electrolyte in the main electrolyte circuit. For example, the condition of the electrolyte may be inferred based on signals received at the controller from one or more sensors, including pH sensors, optical probes, sensors estimating battery SOC, etc. Information from sensors may be used to assess electrolyte health. As an example, if a pH of the electrolyte rises beyond a threshold amount, treatment of the electrolyte may be indicated.

At 604, method 600 includes confirming if adjustment to electrolyte rebalancing is demanded based on the sensor information. For example, if the sensor data indicates that electrolyte health is poor, e.g., pH is rising, ferric iron concentrations are rising above a threshold level, battery SOC is degraded, etc., increased electrolyte rebalancing may be indicated. Electrolyte rebalancing may be increased by increasing a load on electrolyte pumps used to drive electrolyte flow through a second independent circuit in which the injector and at least one rebalancing reactor is included. Increasing the load on the electrolyte pumps may compel pumping of the electrolyte pumps at a higher rate, e.g., the electrolyte pumps may operate with high power output, thereby increasing a rate of electrolyte flow delivered to the rebalancing reactors, the rebalancing reactors arranged downstream of the injector. Conversely, if the sensor data indicates that the electrolyte condition is optimal, electrolyte rebalancing may be adjusted to decrease treatment of the electrolyte at one or more rebalancing reactors by decreasing electrolyte flow. In one example, decreasing treatment of the electrolyte may include reducing the power output of the electrolyte pumps to conserve energy and reduce wear and tear on the pumps.

If adjustment to the electrolyte rebalancing is not demanded, method 600 continues to 606 to continue operating the redox flow battery system under the current operating conditions. Method 600 returns to the start. If, however, adjustment to the electrolyte rebalancing is demanded, method 600 includes modifying operation of the electrolyte pumps at 608. For example, as described, if increased electrolyte rebalancing is demanded, a pumping rate of the electrolyte pumps may be increased. Correspondingly, electrolyte flow may be increased through the second independent circuit, which may divert electrolyte flow from the main electrolyte circuit through a separate loop that extends through the electrolyte tank, e.g., the same electrolyte tank used in method 500 of FIG. 5.

While electrolyte in the second independent circuit does not exchange with electrolyte in the electrolyte tank as the electrolyte flows through the injector located inside the electrolyte tank, hydrogen is suctioned into the injector from the head space of the electrolyte tank. Suction of the hydrogen may be proportional to the electrolyte flow rate through the injector. Variations to the electrolyte flow rate therefore result in proportional changes to hydrogen suction and entrainment into the electrolyte flow. When the electrolyte flow rate is increased, more hydrogen is drawn into the electrolyte flow leaving the electrolyte tank through the second independent circuit, thereby allowing a rate of electrolyte rebalancing (e.g., reduction of ferric iron via hydrogen) at the rebalancing reactor to be increased. When the electrolyte flow rate is decreased, less hydrogen is drawn into the electrolyte flow, resulting in a lower rate of electrolyte rebalancing at the rebalancing reactor.

By varying a speed of pumping provided by the electrolyte pumps, delivery of electrolyte and hydrogen to the rebalancing reactor may be moderated according to electrolyte health. In some examples, by configuring the redox flow battery system with each of the first independent circuit and the second independent circuit, hydrogen flow through the redox flow battery system may be synergistically managed to increase rebalancing efficiency via each of the rebalancing cell and the rebalancing reactor. For example, the first independent circuit may continuously deliver extracted, byproduct hydrogen from the redox battery flow system to the electrolyte tank where the hydrogen may be drawn into the second independent circuit to facilitate electrolyte treatment at the rebalancing reactor. Hydrogen is thereby recycled within the redox flow battery system in a manner dependent on battery performance.

In this way, loss of hydrogen due to leakage may be minimized in a redox flow battery system. The redox flow battery system may be configured with at least one injector arranged inside of an electrolyte tank, the injector fluidically coupled to a rebalancing cell or a rebalancing reactor. When coupled to the rebalancing cell, electrolyte may be pumped through the injector to draw hydrogen into the electrolyte tank for storage thereat. When coupled to the rebalancing reactor, electrolyte may be pumped through the injector to draw hydrogen from the electrolyte tank to the rebalancing reactor. By placing the injector(s) inside of the electrolyte tank, hydrogen circulating is managed via a low cost, efficient strategy that enables hydrogen cycling within the redox flow battery system to provide optimal electrolyte health.

The disclosure also provides support for a redox flow battery system, comprising: an injector arranged inside of an electrolyte tank, wherein the injector is configured to entrain a gas into electrolyte flowing from an inlet of the injector to an outlet of the injector. In a first example of the system, the injector is a venturi and has a suction port proximate to a constriction of the injector, and wherein the gas is entrained into the electrolyte through the suction port. In a second example of the system, optionally including the first example, an electrolyte passage extends between the inlet of the injector and a port in a manway of the electrolyte tank, and wherein the electrolyte passage is fluidically coupled to a main electrolyte circuit of the redox flow battery system. In a third example of the system, optionally including one or both of the first and second examples, a gas passage extends between a suction port of the injector and a second port in a manway of the electrolyte tank, and wherein the gas passage is fluidically coupled to one or more regions of the redox flow battery system where the gas accumulates. In a fourth example of the system, optionally including one or more or each of the first through third examples, the electrolyte is flowed to the injector from a rebalancing cell of the redox flow battery system. In a fifth example of the system, optionally including one or more or each of the first through fourth examples, the electrolyte flowing through the injector is fluidically coupled to hydrogen in a head space of the electrolyte tank through a suction port of the injector, and wherein the electrolyte flowing through the injector is not exchanged with electrolyte stored in the electrolyte tank. In a sixth example of the system, optionally including one or more or each of the first through fifth examples, the electrolyte and the gas are mixed in the outlet of the injector and flowed out of the injector to a rebalancing reactor of the redox flow battery system. In a seventh example of the system, optionally including one or more or each of the first through sixth examples, the gas is hydrogen and the electrolyte includes ferric iron and ferrous iron, and wherein the hydrogen is used to facilitate reduction of ferric iron to ferrous iron at one or more of a rebalancing cell and a rebalancing reactor of the redox flow battery system.

The disclosure also provides support for a method for rebalancing electrolyte in a redox flow battery system, comprising: adjusting operation one or more electrolyte pumps in response to a condition of the electrolyte, the one or more electrolyte pumps driving a flow of the electrolyte through a first injector arranged inside of an electrolyte tank, wherein the flow of the electrolyte through the first injector draws hydrogen into the first injector at a rate proportional to a flow rate of the electrolyte. In a first example of the method, adjusting the operation of the one or more electrolyte pumps includes increasing the flow of the electrolyte when increased rebalancing of the electrolyte is indicated, and decreasing the flow of the electrolyte when optimal electrolyte health is indicated. In a second example of the method, optionally including the first example, increasing the flow of the electrolyte increases electrolyte and hydrogen delivery to a rebalancing reactor arranged downstream of the first injector. In a third example of the method, optionally including one or both of the first and second examples, the hydrogen is drawn into the first injector from a head space of the electrolyte tank through a suction port of the first injector. In a fourth example of the method, optionally including one or more or each of the first through third examples, the electrolyte tank includes a second injector also arranged inside of the electrolyte tank, the second injector configured to flow electrolyte from a rebalancing cell located upstream of the second injector and draw hydrogen from the redox flow battery system into the second injector through a gas passage coupled to a suction port of the second injector. In a fifth example of the method, optionally including one or more or each of the first through fourth examples, the second injector discharges a mixture of the electrolyte and the hydrogen into the electrolyte tank.

The disclosure also provides support for an electrolyte health system for a redox flow battery system, comprising: a main electrolyte circuit, a first independent electrolyte circuit configured to divert electrolyte from the main electrolyte circuit through an electrolyte tank of the redox flow battery system, and at least one injector included in the first independent electrolyte circuit and located inside of the electrolyte tank, the at least one injector having an inlet for receiving electrolyte flow and a suction port for receiving hydrogen, wherein the electrolyte and the hydrogen are mixed in an outlet of the at least one injector prior to discharge from the at least one injector. In a first example of the system, the at least one injector is coupled to a manway of the electrolyte tank via an electrolyte passage, a gas passage, and flanges, and wherein the at least one injector and the manway are detachable from a reservoir of the electrolyte tank as a single unit. In a second example of the system, optionally including the first example, gas fittings for coupling a gas passage to the suction port of the at least one injector are located inside of the electrolyte tank. In a third example of the system, optionally including one or both of the first and second examples, the at least one injector is maintained above a liquid interface of the electrolyte tank. In a fourth example of the system, optionally including one or more or each of the first through third examples, the electrolyte flow, and a flow of hydrogen through the at least one injector, is controlled by electrolyte pumps. In a fifth example of the system, optionally including one or more or each of the first through fourth examples, the at least one injector is a first injector fluidically coupled to a rebalancing cell and configured to deposit a mixture of electrolyte and hydrogen into the electrolyte tank, and wherein the electrolyte tank includes a second injector also arranged inside the electrolyte tank, the second injector included in a second independent electrolyte circuit and configured to deliver a mixture of electrolyte and hydrogen to a rebalancing reactor, the hydrogen obtained from a head space of the electrolyte tank.

FIGS. 2-4 and 7A-8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 2-4 and 7A-8 are drawn approximately to scale, although other dimensions or relative dimensions may be used.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A redox flow battery system, comprising:
an injector arranged inside of an electrolyte tank, wherein the injector is configured to entrain a gas into electrolyte flowing from an inlet of the injector to an outlet of the injector.

2. The redox flow battery system of claim 1, wherein the injector is a venturi and has a suction port proximate to a constriction of the injector, and wherein the gas is entrained into the electrolyte through the suction port.

3. The redox flow battery system of claim 1, wherein an electrolyte passage extends between the inlet of the injector and a port in a manway of the electrolyte tank, and wherein the electrolyte passage is fluidically coupled to a main electrolyte circuit of the redox flow battery system.

4. The redox flow battery system of claim 1, wherein a gas passage extends between a suction port of the injector and a second port in a manway of the electrolyte tank, and wherein the gas passage is fluidically coupled to one or more regions of the redox flow battery system where the gas accumulates.

5. The redox flow battery system of claim 1, wherein the electrolyte is flowed to the injector from a rebalancing cell of the redox flow battery system.

6. The redox flow battery system of claim 1, wherein the electrolyte flowing through the injector is fluidically coupled to hydrogen in a head space of the electrolyte tank through a suction port of the injector, and wherein the electrolyte flowing through the injector is not exchanged with electrolyte stored in the electrolyte tank.

7. The redox flow battery system of claim 6, wherein the electrolyte and the gas are mixed in the outlet of the injector and flowed out of the injector to a rebalancing reactor of the redox flow battery system.

8. The redox flow battery system of claim 1, wherein the gas is hydrogen and the electrolyte includes ferric iron and ferrous iron, and wherein the hydrogen is used to facilitate reduction of ferric iron to ferrous iron at one or more of a rebalancing cell and a rebalancing reactor of the redox flow battery system.

9. A method for rebalancing electrolyte in a redox flow battery system, comprising:
adjusting operation one or more electrolyte pumps in response to a condition of the electrolyte, the one or more electrolyte pumps driving a flow of the electrolyte through a first injector arranged inside of an electrolyte tank, wherein the flow of the electrolyte through the first injector draws hydrogen into the first injector at a rate proportional to a flow rate of the electrolyte.

10. The method of claim 9, wherein adjusting the operation of the one or more electrolyte pumps includes increasing the flow of the electrolyte when increased rebalancing of the electrolyte is indicated, and decreasing the flow of the electrolyte when optimal electrolyte health is indicated.

11. The method of claim 10, wherein increasing the flow of the electrolyte increases electrolyte and hydrogen delivery to a rebalancing reactor arranged downstream of the first injector.

12. The method of claim 9, wherein the hydrogen is drawn into the first injector from a head space of the electrolyte tank through a suction port of the first injector.

13. The method of claim 9, wherein the electrolyte tank includes a second injector also arranged inside of the electrolyte tank, the second injector configured to flow electrolyte from a rebalancing cell located upstream of the second injector and draw hydrogen from the redox flow battery system into the second injector through a gas passage coupled to a suction port of the second injector.

14. The method of claim 13, wherein the second injector discharges a mixture of the electrolyte and the hydrogen into the electrolyte tank.

15. An electrolyte health system for a redox flow battery system, comprising:
a main electrolyte circuit;
a first independent electrolyte circuit configured to divert electrolyte from the main electrolyte circuit through an electrolyte tank of the redox flow battery system; and
at least one injector included in the first independent electrolyte circuit and located inside of the electrolyte tank, the at least one injector having an inlet for receiving electrolyte flow and a suction port for receiving hydrogen, wherein the electrolyte and the hydrogen are mixed in an outlet of the at least one injector prior to discharge from the at least one injector.

16. The electrolyte health system of claim 15, wherein the at least one injector is coupled to a manway of the electrolyte tank via an electrolyte passage, a gas passage, and flanges, and wherein the at least one injector and the manway are detachable from a reservoir of the electrolyte tank as a single unit.

17. The electrolyte health system of claim 15, wherein gas fittings for coupling a gas passage to the suction port of the at least one injector are located inside of the electrolyte tank.

18. The electrolyte health system of claim 15, wherein the at least one injector is maintained above a liquid interface of the electrolyte tank.

19. The electrolyte health system of claim 15, wherein the electrolyte flow, and a flow of hydrogen through the at least one injector, is controlled by electrolyte pumps.

20. The electrolyte health system of claim 15, wherein the at least one injector is a first injector fluidically coupled to a rebalancing cell and configured to deposit a mixture of electrolyte and hydrogen into the electrolyte tank, and wherein the electrolyte tank includes a second injector also arranged inside the electrolyte tank, the second injector included in a second independent electrolyte circuit and configured to deliver a mixture of electrolyte and hydrogen to a rebalancing reactor, the hydrogen obtained from a head space of the electrolyte tank.
